(19) United States
(12) Patent Application Publication
(10) Pub. No.: US 2022/0080411 A1
(43) Pub. Date: Mar. 17, 2022

(54) PHOTOTHERMAL ADHESIVE COMPOSITION CONTAINING GRAPHENE-COPPER SULFIDE COMPOSITE, MANUFACTURING METHOD THEREFOR, AND METHOD FOR FABRICATION OF MICROFLUIDIC CHIP USING SAME

(71) Applicant: SOGANG UNIVERSITY RESEARCH & BUSINESS DEVELOPMENT FOUNDATION, Seoul (KR)

(72) Inventors: Bong Geun CHUNG, Seoul (KR); Jae Hyun LIM, Incheon (KR); Young Jae KIM, Seoul (KR); Jong Min LEE, Daegu (KR); Hyung Woo CHOI, Seoul (KR)

(21) Appl. No.: 17/147,626

(22) Filed: Jan. 13, 2021

(30) Foreign Application Priority Data
Sep. 16, 2020 (KR) 10-2020-0118881

(51) Int. Cl. B01L 3/00; C09J 11/04; C09J 9/00; C09J 5/06; C09J 171/02; C08K 3/04

(52) U.S. Cl. CPC B01L 3/502707; C09J 11/04; C09J 9/00; B82Y 30/00; C09J 171/02; C08K 3/042; C09J 5/06

(57) ABSTRACT

Disclosed herein is a technique for bonding chips made of plastic materials by taking advantage of a photothermal effect of a graphene-copper sulfide composite. Using a photothermal adhesive composition containing the composite, microfluidic chips that pass fluids therethrough with neither leakage nor deformation can be effectively fabricated.

### CROSS REFERENCE TO RELATED APPLICATION

This application claims priority to Korean Patent Application No. 10-2020-0118881, filed on 16 Sep. 2020. The entire disclosure of the application identified in this paragraph is incorporated herein by reference.

### FIELD

The present disclosure relates to a photothermal adhesive composition containing a graphene-copper sulfide composite, a manufacturing method therefor, and a method for fabrication of a microfluidic chip using the same. More specifically, to a technique in which an ultrasonicated graphene oxide (GO) is conjugated with polyethylene glycol (PEG) and mixed with copper sulfide to fabricate composite which is used to induce a photothermal effect, thereby bonding substrates of microfluidic chips to each other.

### BACKGROUND

Generally, the fabrication of microfluidic chips is achieved using a method in which a micrometer-scale structure is formed on a hard ceramic substrate such as a silicon wafer or a glass substrate through an etching process, followed by covering the hard ceramic substrate with a planar substrate and bonding the same, or a method in which a structure is fabricated on an elastomeric polymer material, most notably polydimethylene siloxane (PDMS), by soft-lithography.

Among of them, the method for fabricating thin film chip replicas or microfluidic chips using glass substrates is suggested by Korean Patent Number 10-0788458. With respect to the microfluidic chips fabricated using hard materials such as silicon wafers, glass substrates, etc., however, not only is the adhesion between the microstructure formed substrate and the planar substrate difficult, but also fine gaps are generated during fabrication processes or use, leading to water leakage therefrom. Furthermore, the ceramic material is vulnerable to an external impact.

There has recently been an increase in a need for research for microfluidic chips of composite plastics that are suitable for mass production and commercialization. Conventional bonding methods are carried out in a viscosity-based adhesive manner in which interfaces in the plastic materials for microfluidic chips are attached with high heat under a high pressure or by an adhesive agent or an adhesive film.

However, such conventional processes suffer from the disadvantages that the microstructures are prone to deformation due to heat and pressure; the microfluidic channels may be blocked with the fluidization of the adhesive agent or with the collapse thereof by the pressure-caused deformation of the plastic material; and high costs are required for the initial facility as well as the maintenance of the process.

### SUMMARY

### Technical Problem

In order to solve the problems encountered with the conventional techniques, the present inventors developed a technique for bonding chips of plastic materials using the photothermal effect of a graphene-copper sulfide composite. A technique for bonding chips plays a critical role in preventing a sample from leaking from the channel and in connecting chips to each other.

The graphene-copper sulfide composite according to the present disclosure allows chips made of plastics to be bonded within a short period of time upon exposure to a near infrared (NIR) laser. Existing as a liquid phase low in viscosity and density, the bonding material does not permit the occurrence of gaps between the plastic chips.

In addition, the present inventors confirmed that the chips did not leak fluids without deformation, as analyzed for physical and mechanical characteristics. Therefore, the technique for bonding microfluidic chips made of plastics using a photothermal effect of the graphene-copper sulfide composite can not only be used in research in which bonding needs to be maintained, like PCR, etc. where temperatures inside chips are high or experiments are performed for a long time, but also applied to the interface of a chip and a chip in research where modules of various chips are assembled.

Accordingly, a purpose of the present disclosure is to provide a photothermal adhesive composition containing a graphene-transition metal compound composite.

Another purpose of the present disclosure is to provide a method for manufacturing a photothermal adhesive composition containing a graphene-transition metal compound composite, the method comprising the steps of:

reacting graphene with a hydrophilic polymer and then reducing the graphene; and

mixing the graphene with transition metal compound nanoparticles to form a composite.

A further purpose of the present disclosure is to provide a method for fabrication of a microfluidic chip using a photothermal adhesive composition containing a graphene-transition metal compound composite, the method comprising:

a loading step of loading the photothermal adhesive composition to a target site on a microfluidic chip lower substrate;

a first laser irradiation step of irradiating a laser to the target site; and

a second laser irradiation step of contacting a microfluidic chip upper substrate with the target site on the lower substrate, followed by irradiating a laser thereto.

A still further purpose of the present disclosure is to provide a use of a graphene-transition metal compound composite in bonding microfluidic chips through a photothermal effect.

### Technical Solution

The present disclosure relates to a photothermal adhesive composition containing a graphene-copper sulfide composite, a manufacturing method therefor, and a method for fabrication of a microfluidic chip using same. The photothermal adhesive composition according to the present disclosure can be used to bond chips made of plastics through a photothermal effect, without applying a pressure thereto.

The present inventors developed a technique of using the photothermal effect of a graphene-copper sulfide composite in bonding chips made of plastic materials and succeeded in bonding plastic chips by applying a laser to the graphene-copper sulfide composite within a short period of time. Also, the present inventors identified that the bonding material, which exists as a liquid phase low in viscosity and density, did not allow the generation of gaps between plastic chips.

Below, a detailed description will be given of the present disclosure.

A purpose of the present disclosure is to provide a photothermal adhesive composition containing a graphene-transition metal compound composite.

In an embodiment of the present disclosure, the graphene may be graphene oxide (GO) that is reduced after a reaction with a hydrophilic polymer.

In an embodiment of the present disclosure, the hydrophilic polymer may be at least one selected from the group consisting of polyethyleneglycol (PEG), polyvinylalcohol (PVA), polyacrylic acid (PAA), polyvinylpyrrolidone (PVP), polyurethane (PU), and polytetrafluoroethylene (PTFE), but is not limited thereto. For example, the hydrophilic polymer may be PEG.

In an embodiment of the present disclosure, the photothermal adhesive composition may contain graphene:transition metal compound at a weight ratio of from 1:1 to 1:4 or from 1:2 to 1:4, for example, from 1:3 to 1:4, but without limitations thereto. The graphene and the transition metal compound form a composite by physical mixing.

The transition metal compound may comprise at least one transition metal selected from the group consisting of coper (Cu), molybdenum (Mo), tungsten (W), titanium (Ti), zirconium (Zr), hafnium (Hf), rhenium (Re), vanadium (V), lead (Pd), niobium (Nb), platinum (Pt), tantalum (Ta), and iron (Fe) and may include copper, but without limitations thereto.

The transition metal compound may comprise at least one chalcogen element selected from the group consisting of sulfur (S), selenium (Se), and tellurium (Te) and may comprise, for example, sulfur, but without limitations thereto.

Another purpose of the present disclosure is to provide a method for manufacturing a photothermal adhesive composition containing a graphene-transition metal compound composite, the method comprising the steps of:

reacting graphene with a hydrophilic polymer and then reducing the graphene; and

mixing the graphene with transition metal compound nanoparticles to form a composite.

In an embodiment of the present disclosure, the graphene may be graphene oxide.

In an embodiment of the present disclosure, the hydrophilic polymer may be at least one selected from the group consisting of polyethyleneglycol (PEG), polyvinylalcohol (PVA), polyacrylic acid (PAA), polyvinylpyrrolidone (PVP), polyurethane (PU), and polytetrafluoroethylene (PTFE), but is not limited thereto. For example, the hydrophilic polymer may be PEG.

In an embodiment of the p, the hydrophilic polymer may be PEG.resent disclosure, the photothermal adhesive composition may contain a mixture of graphene:transition metal compound at a weight ratio of from 1:1 to 1:4 or from 1:2 to 1:4, for example, from 1:3 to 1:4, but without limitations thereto.

The transition metal compound may comprise at least one transition metal selected from the group consisting of coper (Cu), molybdenum (Mo), tungsten (W), titanium (Ti), zirconium (Zr), hafnium (Hf), rhenium (Re), vanadium (V), lead (Pd), niobium (Nb), platinum (Pt), tantalum (Ta), and iron (Fe) and may include copper, but without limitations thereto.

The transition metal compound may comprise at least one chalcogen element selected from the group consisting of sulfur (S), selenium (Se), and tellurium (Te) and may comprise, for example, sulfur, but without limitations thereto.

A further purpose of the present disclosure is to provide a method for fabrication of a microfluidic chip using a photothermal adhesive composition containing a graphene-transition metal compound composite, the method comprising:

a loading step of loading the photothermal adhesive composition to a target site on a lower substrate for microfluidic chips;

a first laser irradiation step of irradiating a laser to the target site; and

a second laser irradiation step of contacting an upper substrate for the microfluidic chips with the target site on the lower substrate, followed by irradiating a laser thereto.

In an embodiment of the present disclosure, the loading step may comprise dropwise loading the photothermal adhesive composition in a volume of from 1 to 20 μL, from 1 to 15 μL, or from 1 to 10 μL, for example, from 1 to 5 μL, but without limitations thereto.

The loading step is adapted to load three or more drops of the photothermal adhesive composition per 1 cm of the length to be attached. More drops of the photothermal adhesive composition give higher tensile strength to the attachment site, but the drops are closer to each other and more likely to merge, resulting in one drop with a large volume. Thus, the division of drops is allowed within the extent that individual drops are not combined with each other.

In an embodiment of the present disclosure, the first laser irradiation step, which is a pre-heating step, is to irradiate a near infrared (NIR) laser beam at an intensity of 1.00 to 3.00, 1.25 to 3.00, 1.50 to 3.00, 1.75 to 3.00, 2.00 to 3.00, 2.25 to 3.00, 2.50 to 3.00, 1.00 to 2.75, 1.25 to 2.75, 1.50 to 2.75, 1.75 to 2.75, 2.00 to 2.75, or 2.25 to 2.75 W, for example, 2.50 to 2.75 W, but without limitations thereto.

The first laser irradiation step may be carried out for 4 to 15 seconds, for example, 8 to 12 seconds, but without limitations thereto.

In an embodiment of the present disclosure, the second laser irradiation step, which is a heating step, is to irradiate an NIR laser beam at an intensity of 1.00 to 3.00, 1.25 to 3.00, 1.50 to 3.00, 1.75 to 3.00, 2.00 to 3.00, 2.25 to 3.00, 2.50 to 3.00, 1.00 to 2.75, 1.25 to 2.75, 1.50 to 2.75, 1.75 to 2.75, 2.00 to 2.75, or 2.25 to 2.75 W, for example, 2.50 to 2.75 W, but without limitations thereto.

The second laser irradiation step may be carried out for 20 to 40 seconds, for example, 25 to 35 seconds, but without limitations thereto.

In an embodiment of the present disclosure, when a laser beam is irradiated at an intensity of 2.5 W or higher in the first or the second laser irradiation step, the photothermal adhesive composition rapidly and excessively increases in temperature so that the water splatters, and the excessive heat deforms the surface of the substrate. Thus, the intensity of the laser beam is limited to the value. In addition, the temperature increment is not large when the intensity of laser beams exceeds 2.50 W. For stabilization, the upper limit of the intensity of laser beams is set to be 2.50 W in the adhesion step.

In an embodiment of the present disclosure, the microfluidic chip may be made of poly(methyl methacrylate) (PMMA) or polycarbonate (PC), for example, PMMA, but without limitations thereto.

### Advantageous Effects

The present disclosure relates to a technique for bonding chips made of plastic materials by taking advantage of a photothermal effect of a graphene-copper sulfide composite. Using A photothermal adhesive composition containing the composite, microfluidic chips that pass fluids therethrough with neither leakage nor deformation can be effectively fabricated.

### BRIEF DESCRIPTION OF THE DRAWINGS

The above and other aspects, features and advantages of the present disclosure will be more apparent from the following detailed description taken in conjunction with the accompanying drawings, in which:

FIG. 1A is a schematic view illustrating processes of synthesizing a photothermal adhesive composition according to an embodiment of the present disclosure;

FIG. 1B is a graph of temperature changes with mixing ratios of rGO-PEG/CuS composites in the photothermal adhesive composition according to an embodiment of the present disclosure;

FIG. 2A shows transmission electron microscope (TEM) images before and after reduced graphene and copper sulfide were mixed (graphene-copper sulfide composite (rGO-PEG/CuS)) in the photothermal adhesive composition;

FIG. 2B shows FT-IR (Fourier-transform infrared spectroscopy) spectra of GO-PEG used for the photothermal adhesive composition manufactured according to an embodiment of the present disclosure before and after reduction.

FIG. 2C shows absorption spectra of the rGO-PEG/CuS composite in the photothermal adhesive composition according to an embodiment of the present disclosure;

FIG. 3A is a photographic image of a microfluidic chip according to an embodiment of the present disclosure;

FIG. 3B is a schematic diagram illustrating processes of bonding substrates using a photothermal adhesive composition according to an embodiment of the present disclosure;

FIG. 4A shows thermographic images, taken by a thermographic camera during application of a laser, illustrating bonding processes using the rGO-PEG/CuS composite according to an embodiment of the present disclosure;

FIG. 4B is a graph showing a relationship between the laser intensity used for bonding processes according to an embodiment of the present disclosure and the time to reach the melting point of poly(methyl methacrylate) (PMMA);

FIG. 4C is a plot showing a relationship between the laser intensity used for bonding processes according to an embodiment of the present disclosure and the heating rate;

FIG. 5A is a graph showing a relationship between drop volumes of the photothermal adhesive composition according to an embodiment of the present disclosure and tensile strength;

FIG. 5B is a graph showing relationship between the number of drops of the photothermal adhesive composition according to an embodiment of the present disclosure and tensile strength;

FIG. 5C is a photographic image showing gap spacing formed between bonded surfaces by numbers of drops of the photothermal adhesive composition according to an embodiment of the present disclosure;

FIG. 5D is a graph of lengths of gap spacings formed between bond surfaces by numbers of drops of the photothermal adhesive composition according to an embodiment of the present disclosure;

FIG. 6A shows photographic images of microfluidic chips fabricated according to an embodiment of the present invention to examine whether leakage from the microfluidic chips occurs by type of fluids; and

FIG. 6B is a photographic image showing that when water was applied thereto, the microfluidic chip fabricated according to an embodiment of the present disclosure did not leak the fluid.

### DETAILED DESCRIPTION

Hereinafter, the present invention will be described in detail with reference to examples. These examples are only for illustrating the present invention more specifically, and it will be apparent to those skilled in the art that the scope of the present invention is not limited by these examples.

Unless otherwise noted, “%” used to indicate concentrations of particular substances means represents (weight/weight) % for solid/solid, (weight/volume) % for solid/liquid, and (volume/volume) % for liquid/liquid through the specification.

### EXAMPLE

### Example 1: Preparation of Graphene-Copper Sulfide Composite

### 1-1. Method for Preparation of Graphene-Copper Sulfide Composite

To 20 mL of graphene oxide (GO, 1 mg/m L) was added 100 mg of each of EDC (N-(3-dimethylaminopropyl)-N′-ethylcarbodiimide) and NHS (N-hydroxysuccimide), followed by exposure to ultrasonic waves for 1 hour. Then, the solution was stirred, together with mPEG-NH₂ (methoxy polyethylene glycol amine), for 18 hours to react GO with mPEG. Afterwards, reduction was performed at 90° C. under the condition of 20 vol % (0.05%) diazene (N2H2).

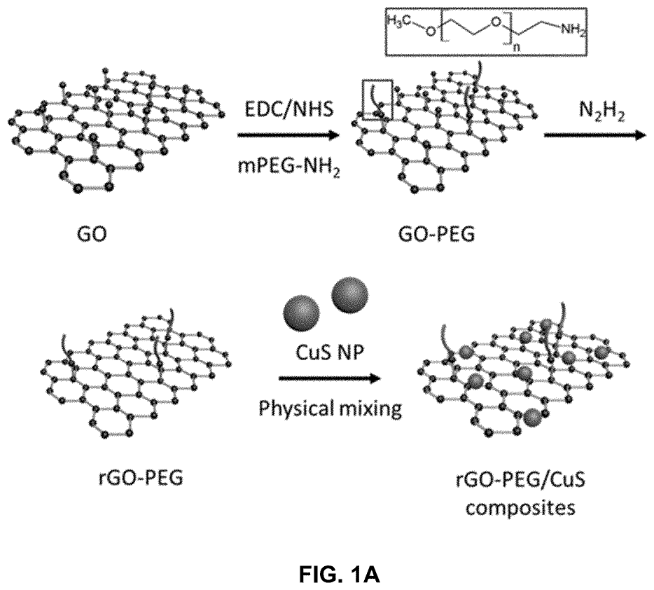

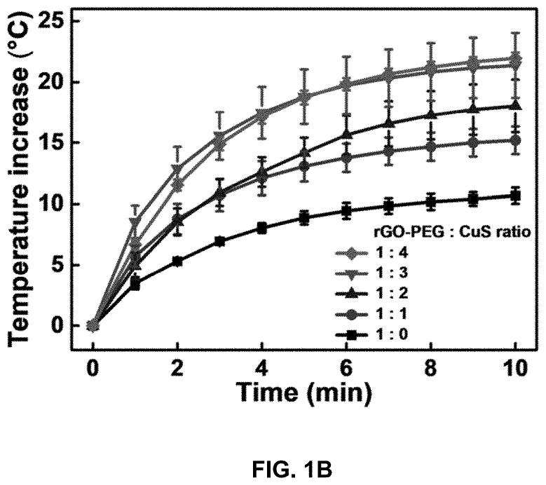

CuS nanoparticles were synthesized by stirring 14 mg of CuCl₂ and 20 mg of trisodium citrate and then reacting the same with 7.8 mg of Na₂S at 90° C. for 15 minutes. As shown in FIG. 1a, the rGO-PEG and the CuS nanoparticles thus prepared were mixed with each other before bonding.

Dilution was made so as to mix rGO-PEG (0.25 mg/mL) and CuS nanoparticles (0.25 to 1.00 mg/mL) at various ratios. After application of 808 nm NIR laser beam at 1 W/cm², temperature increments (ΔT, ° C.) were measured.

TABLE 1

| rGO-PEG:CuS | 1:0 | 1:1 | 1:2 | 1:3 | 1:4 |
|---|---|---|---|---|---|
| Temperature change | 10.6 | 15.2 | 18.0 | 21.3 | 21.9 |
| after 10 min. (° C.) | | | | | |

As shown in Table 1 and FIG. 1b, rGO-PEG in the control increased by about 10° C. The temperature was increased uniformly until the ratio of rGO-PEG:CuS=1:3, but did not significantly change between the ratios 1:4 and 1:3. Therefore, the appropriate ratio of rGO-PEG:CuS for photothermal bonding was set to be 1:3.

### 1-2. Characterization of Graphene-Copper Sulfide Composite

The synthesized composites were assessed for morphology by FETEM (Field-Emission Transmission Electron Microscopy, 200 kV).

In Example 1-1, the CuS nanoparticles having a diameter of 10 nm were synthesized and the rGO-PEG was observed to be in a sheet form with a width of 1 μm.

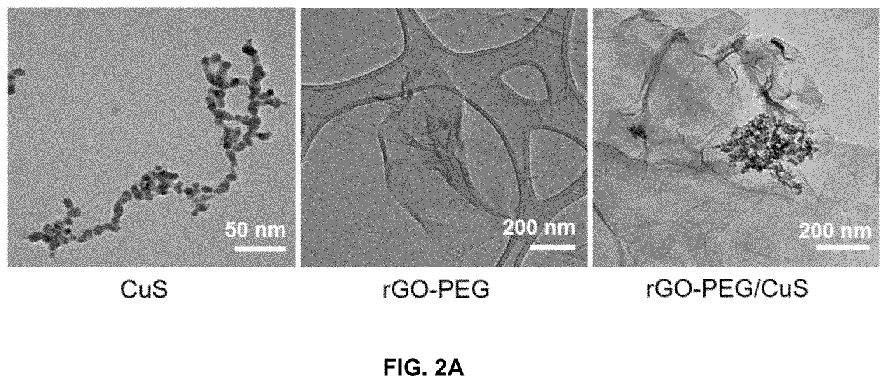

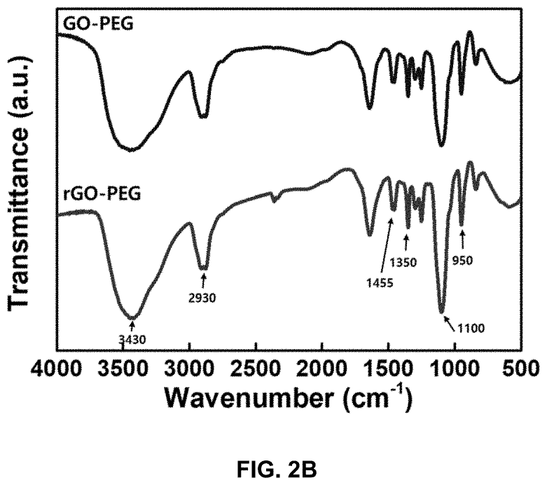

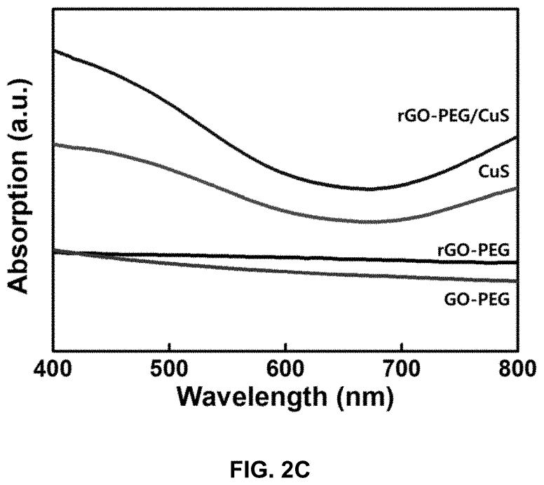

The rGO-PEG/CuS composite with a mass ratio of 1:3 was morphologically examined by transmission electron microscopy (TEM). As shown in the images of FIG. 2a, a plurality of CuS nanoparticles was located on the surface of the rGO-PEG.

GO-PEG and rGO-PEG were analyzed by FT-IR (Fourier-transform infrared spectroscopy). As can be seen in the spectra of FIG. 2b, the characteristic vibrations of PEG were detected at 1,350 cm⁻¹ and 1450 cm⁻¹. In addition, C—O—C vibrations were detected at 900 cm⁻¹ and 1,100 cm⁻¹. Furthermore, the reduction of GO-PEG Diminished the peak accounting for 0-H stretching vibrations (3,450 cm⁻¹).

Evaluation was made of optical characteristics of the composites. To this end, rGO-PEG/CuS, CuS, rGO-PEG, and GO-PEG were each dispersed at a concentration of 0.1 mg/mL in distilled water and absorbance at the wavelength band of 400 to 900 nm was read using UV-Vis (ultraviolet-visible) spectroscopy.

As shown in FIG. 2c, rGO-PEG has relatively stronger absorption than GO-PEG in the near-infrared (NIR) ray at the band of 750 to 900 nm.

The CuS nanoparticles also absorbed light at the NIR band. A dilution of rGO-PEG and CuS nanoparticles (rGO-PEG/CuS) was measured to show stronger NIR absorption than conventional CuS nanoparticles.

### Example 2: Adhesion Condition for Graphene-Copper Sulfide Composite

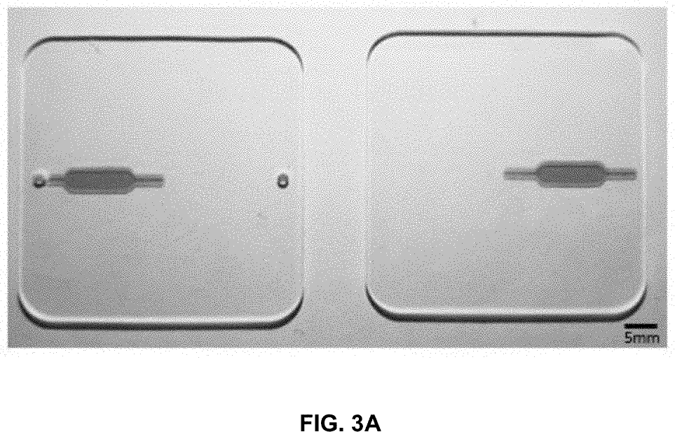

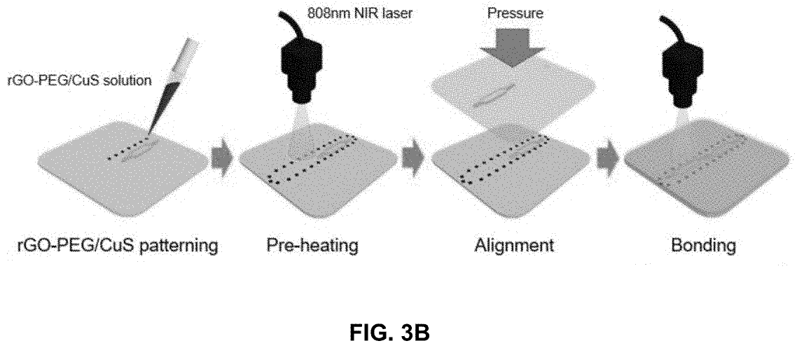

Plastic microfluidic chips to which the present invention is applied were fabricated with PMMA (poly(methylmethacrylate)), which has a melting point of 150° C. As can be seen in FIG. 3a, the upper substrate was perforated at two sites while the lower substrate had a channel only.

The attachment between the plastic chip upper substrate and the lower substrate for fabrication of microfluidic chips was performed according to the protocol illustrated in FIG. 3b. First, the rGO-PEG:CuS composite was dropwise loaded around the channel on the plastic chip lower substrate. Heat was primarily applied using a laser. After thermal application, the plastic chip lower substrate was covered with the plastic chip upper substrate. Heat was again applied using a laser so as to bond the chip.

### 2-1. Optimization of Laser Intensity

If the graphene-copper sulfide composite is intactly disposed between the upper and the lower substrate, it is spread over the substrate because its surface tension decreases due to the wettability of water. This condition is insufficient to apply laser beams, with the consequent failure of exhibiting a sufficient bonding strength.

In order to prevent such a condition, pre-treatment with a laser was conducted. In this regard, temperatures of the graphene-copper sulfide composite loaded on the chip lower substrate were examined by a thermographic camera before the application of the laser to the lower substrate, after the lower substrate is pre-heated with the laser, and after the lower substrate covered with the upper substrate was heated subsequent to the pre-heating.

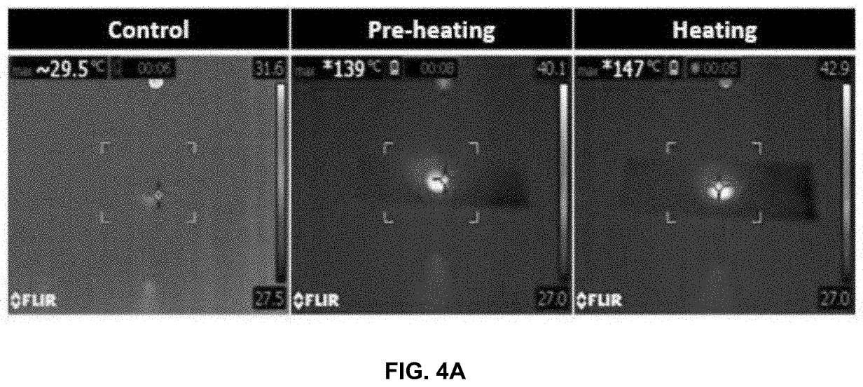

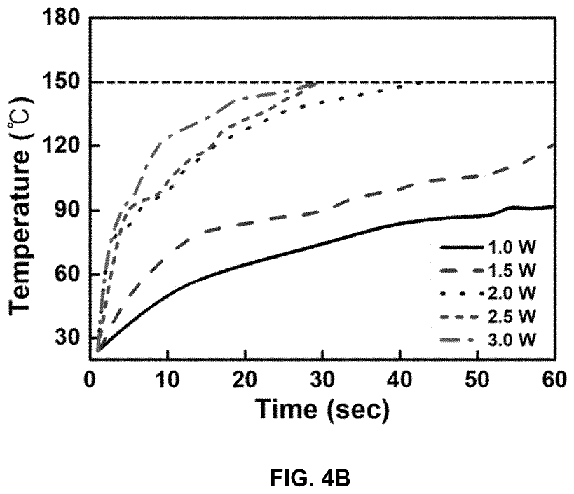

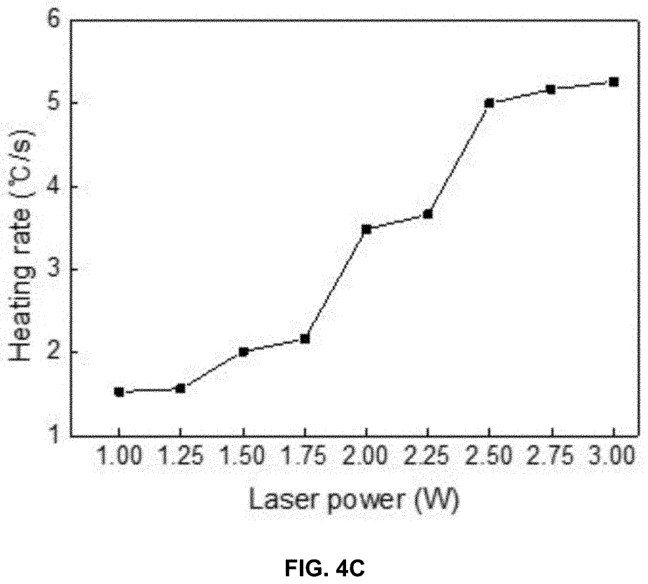

As can be seen in FIG. 4a, the application of an NIR laser only did not alter temperatures on the surface of the PMMA chips, but the photothermal effect of the graphene-copper sulfide composite increased the temperature to the melting point of PMMA, making the bonding condition optimal. In addition, the photothermal effect was maintained in the combination of the upper and lower substrates as well as in the PMMA lower substrate only, which demonstrates that the photothermal effect is not reduced even upon the PMMA substrates are overlapped.

Analysis was made of a relationship between the intensity of the laser and time to reach the melting point of PMMA, that is, 150° C., and between the intensity of the laser and heating rate.

As shown in FIG. 4b, when the laser was higher in intensity, the times to reach the melting point and the gap therebetween were shorter. However, an excessive intensity of the laser transfers heat to the graphene-copper sulfide composite, causing the composite to splatter.

In order to solve the problem, selection was made of the range of 2.50 to 3.00 W in which the intervals between times to reach 150° C., based on the data of FIG. 4c, and the minimal value 2.50 W was set forth as the intensity of the laser for subsequent experiments.

### 2-2. Optimization of Condition for Use of Graphene-Copper Sulfide Composite

In order to examine the bonding strength of the chip bonded in the optimal heating condition, the graphene-copper sulfide composite applied to the substrate was measured for tensile strength by volume and number.

Drops of the composite with respective volumes of 5 μL, 10 μL, and 15 μL were loaded on plastic lower substrates and pre-heated using an NIR laser at 2.50 W for 10 seconds. The lower substrates were covered with corresponding upper substrates and heated for 30 seconds to bond the lower and the upper substrates. Tensile strength was measured using a tension compression machine.

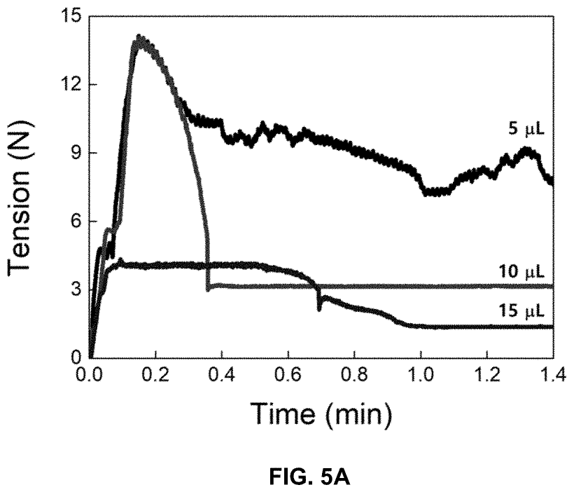

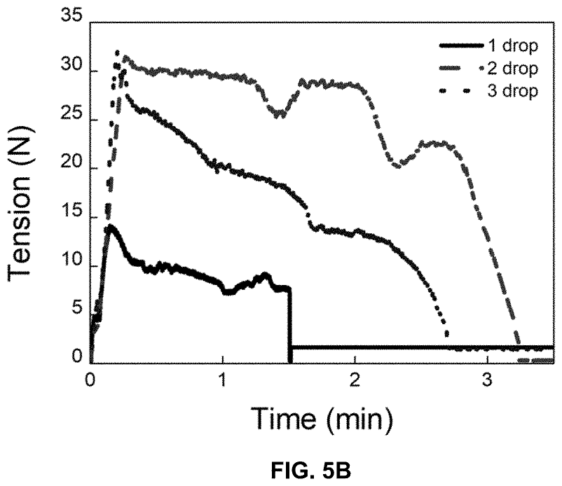

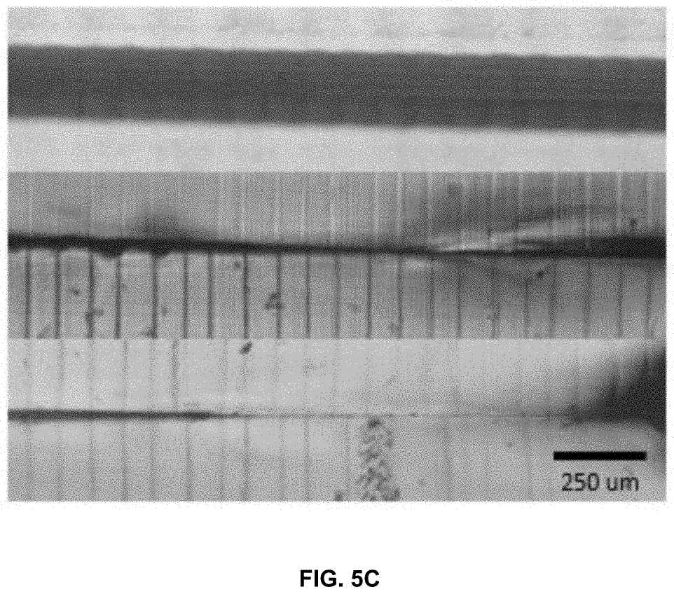

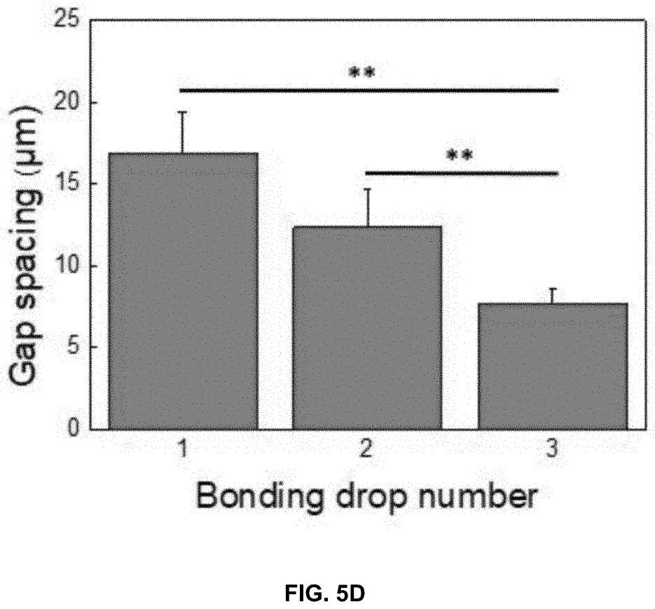

As shown in FIG. 5a, the tensile strength after bonding decreased with the increase of volume in drops of the graphene-copper sulfide composite.

2 Tensile strength was measured using a tension compression machine.

Among the substrates to which one, two, and three drops were loaded per 1 cm, the highest tensile strength was detected in the substrate having three drops loaded per 1 cm thereto. In light of the tendency toward the increase of tensile strength with the abundance of drops of the composite, as many drops of the composite as possible were loaded insofar as the drops were not overlapped with each other. As a result, the tensile strength was increased in proportion to the number of drops of the composite on the surface of the substrates.

In addition, the bonded surface was scrutinized. To this end, gap spacings between the bonded plastic surfaces were measured according to the number of drops of the composite. As shown in FIG. 5c, measurements of the gap spacing are given for the substrates to which one, two, and three drops were applied in that order from the top.

TABLE 2

| Number of drop | 1 | 2 | 3 |
|---|---|---|---|
| Gap spacing (μm) | 16.92 | 12.33 | 7.65 |

As can be seen from the data of Table 2 and FIG. 5d, the gap spacing was decreased with the increase of the number of drops within a given area. Thus, it was concluded that when substrates are bonded to each other for fabrication of microfluidic chips, as many small-sized drops of the graphene-copper sulfide composite as possible are disposed on a substrate without contact therebetween.

### Example 3: Preventive Effect of Graphene-Copper Sulfide Composite on Water Leakage

The graphene-copper sulfide composite was analyzed for preventive effect on water leakage. To this end, 24 drops of the graphene-copper sulfide composite, each having a volume of 5 μL, were loaded around a channel on a plastic lower substrate, followed by bonding.

The microfluidic chip thus fabricated was examined for functional integrity. In this regard, leakage was monitored by passing various fluids including water, dimethyl sulfoxide (DMSO), and mineral oil through the channel.

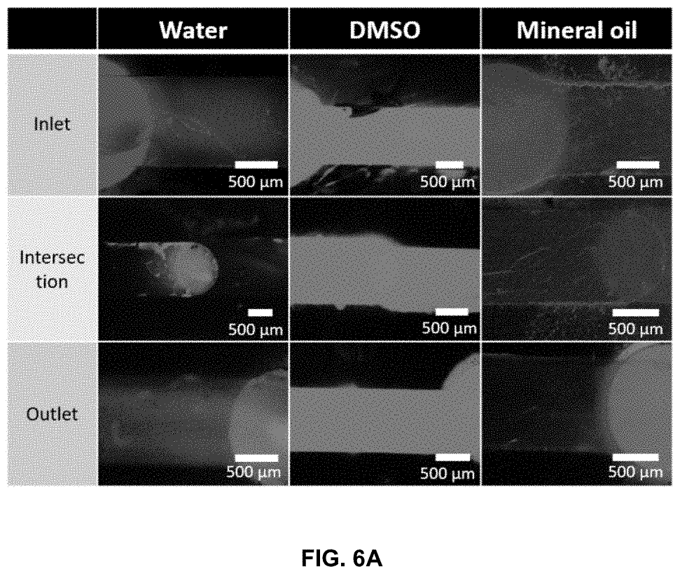

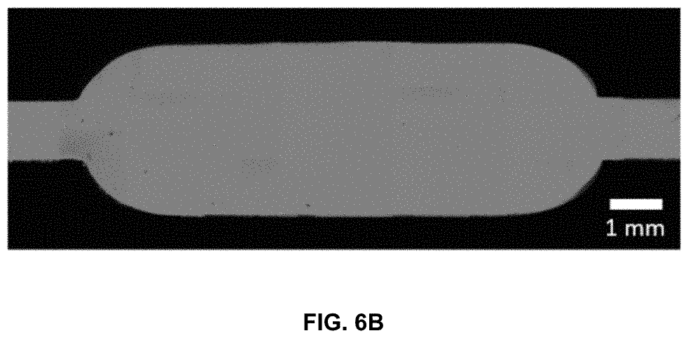

The flow rate of each fluid was increased by 10 μL/min in every 10 seconds while the channel was monitored for internal collapse. As shown in FIG. 6a, the channel did not permit leakage for water until 200 μL/min in, but was observed to collapse at 200 μL/min in for DMSO and 25 μL/min in for mineral oil. The data imply that the endurance range of the bonded sites depends on the viscosity of the fluid passing through the channel.

In light of the fact that flow analysis of conventional microchips for water is based on the measurements obtained at up to 200 μL/min in, the chips bonded by the graphene-copper sulfide composite were considered to be suitable for testing microfluidics of water.

As can be seen in FIG. 6b, when water was flowed at a certain rate, the chip was observed to leak the water from none of the bonded sites. Therefore, the microfluidic chip of the present disclosure for use as a module chip is suitable for testing water-soluble substances.

What is claimed is:

1. A photothermal adhesive composition, comprising a graphene-transition metal compound composite.

2. The photothermal adhesive composition of claim 1, wherein the graphene is a graphene oxide (GO) that is reacted with a hydrophilic polymer and then reduced.

3. The photothermal adhesive composition of claim 2, wherein the hydrophilic polymer is at least one selected from the group consisting of polyethylene glycol (PEG), polyvinyl alcohol (PVA), polyacrylic acid (PAA), polyvinyl pyrrolidone (PVP), polyurethane (PU), and polytetrafluoroethylene (PTFE).

4. The photothermal adhesive composition of claim 1, wherein the graphene-transition metal compound composite contains a mixture of graphene:transition metal compound at a weight ratio of 1:1 to 1:4.

5. The photothermal adhesive composition of claim 1, wherein the transition metal compound comprises at least one transition metal selected from the group consisting of copper (Cu), molybdenum (Mo), tungsten (W), titanium (Ti), zirconium (Zr), hafnium (Hf), rhenium (Re), vanadium (V), lead (Pd), niobium (Nb), platinum (Pt), tantalum (Ta), and iron (Fe).

6. The photothermal adhesive composition of claim 1, wherein the transition metal compound comprises at least one chalcogen element selected from the group consisting of sulfur (S), selenium (Se), and tellurium (Te).

7. A method for manufacturing a photothermal adhesive composition containing a graphene-transition metal compound composite, the method comprising the steps of:
reacting graphene with a hydrophilic polymer and then reducing the graphene; and
mixing the graphene with transition metal compound nanoparticles to form a composite.

8. The method of claim 7, wherein the graphene is graphene oxide (GO).

9. The method of claim 7, wherein the hydrophilic polymer is at least one selected from the group consisting of polyethylene glycol (PEG), polyvinyl alcohol (PVA), polyacrylic acid (PAA), polyvinyl pyrrolidone (PVP), polyurethane (PU), and polytetrafluoroethylene (PTFE).

10. The method of claim 7, wherein the graphene-transition metal compound composite contains a mixture of graphene:transition metal compound at a weight ratio of 1:1 to 1:4.

11. The method of claim 7, wherein the transition metal compound comprises at least one transition metal selected from the group consisting of copper (Cu), molybdenum (Mo), tungsten (W), titanium (Ti), zirconium (Zr), hafnium (Hf), rhenium (Re), vanadium (V), lead (Pd), niobium (Nb), platinum (Pt), tantalum (Ta), and iron (Fe).

12. The method of claim 7, wherein the transition metal compound comprises at least one chalcogen element selected from the group consisting of sulfur (S), selenium (Se), and tellurium (Te).

13. A method for fabrication of a microfluidic chip using a photothermal adhesive composition containing a graphene-transition metal compound composite, the method comprising:
a loading step of loading the photothermal adhesive composition to a target site on a microfluidic chip lower substrate;
a first laser irradiation step of irradiating a laser to the target site; and
a second laser irradiation step of contacting a microfluidic chip upper substrate with the target site on the lower substrate, followed by irradiating a laser thereto.

14. The method of claim 13, wherein the loading step comprises dropwise loading the photothermal adhesive composition in a volume of from 1 to 20 μL.

15. The method of claim 13, wherein the loading step is adapted to load three or more drops of the photothermal adhesive composition per 1 cm of the length to be attached.

16. The method of claim 13, wherein the microfluidic chip is made of poly(methyl methacrylate) (PMMA) or polycarbonate (PC).
